(19) United States
(12) Patent Application Publication
(10) Pub. No.: US 2007/0091116 A1
(43) Pub. Date: Apr. 26, 2007

(54) System and method for creating an ICC profile of an LCD

(75) Inventors: Ming-Lei Niu, Shenzhen (CN); Jing-Hu Song, Shenzhen (CN); Kuang-Liang Huang, MiaoLi (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/584,886

(22) Filed: Oct. 23, 2006

(30) Foreign Application Priority Data
Oct. 21, 2005 (CN) 200510100564.3

(51) Int. Cl. G09G 3/36

(52) U.S. Cl. 345/603; 345/88

(57) ABSTRACT

An exemplary system for creating an international color consortium (ICC) profile of a liquid crystal display (LCD) (20) is disclosed. The system includes: a setting module (101) is configured for setting parameters of color pictures; a transmitting module (102) is configured for transmitting the set parameters of color pictures to the LCD for displaying of corresponding color pictures; a receiving module (103) is configured for receiving chromaticity coordinates that are generated according to color information of the color pictures displayed by the LCD; a processing module (104) is configured for converting the chromaticity coordinates into numerical coordinates of a profile connection space (PCS); and a generating module (105) is configured for generating an ICC profile according to the numerical coordinates of the PCS. A related method is also provided.

### BACKGROUND OF THE INVENTION

1. Field of the Invention

The present invention is generally related to a system and method for creating an international color consortium (ICC) profile of a liquid crystal display (LCD).

2. Related Art

In the field of image rendering, there are a number of different formats in which an image and the color space transformation of that image may be represented. One specific type of format is defined by the International Color Consortium (ICC) (International Color Consortium is a registered trademark of the International Color Consortium). The format defined by the ICC is directed to providing an image profile format (or specification) that allows for cross-platform device usage. Such image profile format can be used to translate color data created in one electronic device into another electronic device's native color space. In particular, the use of a standardized image profile format by operating system vendors allows end users to move image profiles (and images with embedded image profiles) between different operating systems fully intact. For example, a device's image profiles provide color management systems with the information necessary to convert color data between native device color spaces and device-independent color spaces.

The ICC specification divides color devices into three broad classifications: input devices, display devices, and output devices. For each device class, a series of basic algorithmic models are described. These models perform the transformation between color spaces, and provide a range of color quality and performance results. The necessary parameter data to implement these models is described in the required portions of the appropriate device profile descriptions. The profile structure is defined as a header followed by a tag table followed by a series of tagged elements that can be accessed randomly and individually.

One of the main efforts of the ICC is to provide a universal approach to obtain a clear definition of all the variables involved in the handling of colors by a device. This approach is based on a working concept called a “profile connection space,” wherein each device has a “color profile” that describes the color management parameters used by the device. Most color profiles are generated by software in an enterprise, with each kind of color profile generated corresponding to a particular kind of self-contained device produced by the enterprise. If another enterprise needs to have a color profile manufactured for its products by utilizing the software, the purchase price of such color profile can be high.

Therefore, what is needed is a system and method for creating an ICC profile simply and conveniently.

### SUMMARY

A system for creating an international color consortium (ICC) profile of a liquid crystal display (LCD) is provided. The system is configured in a host computer. The system includes a setting module, a transmitting module, a receiving module, a processing module, and a generating module. The setting module is configured for setting parameters of color pictures. The transmitting module is configured for transmitting the set parameters of color pictures to the LCD for displaying of corresponding color pictures. The receiving module is configured for receiving chromaticity coordinates that are generated according to color information of the color pictures displayed by the LCD. The processing module is configured for converting the chromaticity coordinates into numerical coordinates of a profile connection space (PCS). The generating module is configured for generating an ICC profile according to the numerical coordinates of the PCS.

A method for creating an ICC profile of an LCD includes: setting parameters of color pictures; displaying color pictures according to the set parameters; gathering color information of the color pictures, and generating chromaticity coordinates according to the color information; converting the chromaticity coordinates into numerical coordinates of the PCS; and generating an ICC profile according to the numerical coordinates of the PCS.

Other advantages and novel features will be drawn from the following detailed description of preferred embodiments including a preferred method together with the attached drawings.

### BRIEF DESCRIPTION OF THE DRAWINGS

FIG. 1 is a schematic diagram of hardware configuration of a system for creating an international color consortium (ICC) profile of a liquid crystal display (LCD) in accordance with a preferred embodiment of the present invention, together with an LCD and a color analyzing device, wherein the system is configured in a memory of a host computer.

FIG. 2 is a schematic diagram of function modules of color space transformation, the function modules being provided in the system of FIG. 1.

FIG. 3 is a schematic diagram of key software function modules of the system of FIG. 1.

FIG. 4 is a flowchart of a preferred method for creating an ICC profile of an LCD in accordance with another preferred embodiment of the present invention.

### DETAILED DESCRIPTION OF THE EMBODIMENTS

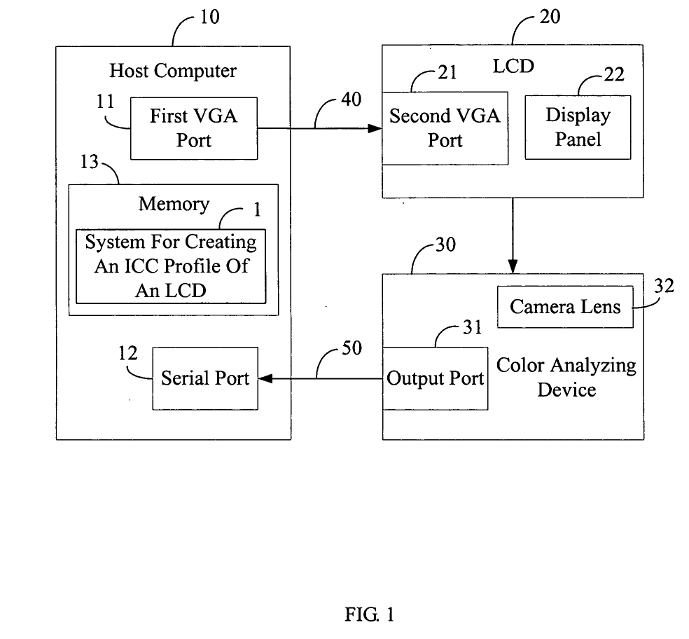

FIG. 1 is a schematic diagram of hardware configuration of a system for creating an international color consortium (ICC) profile of a liquid crystal display (LCD) (hereinafter, “the system 1”) in accordance with a preferred embodiment of the present invention, together with an LCD 20 and a color analyzing device 30. The system 1 is configured in a memory 13 of a host computer 10. The host computer 10 can be an IBM clone personal computer (PC), which typically is installed with a first video graphics array (VGA) port 11, a serial port 12, and a memory 13. The host computer 10 is connected with the LCD 20 and the color analyzing device 30.

The system 1 is configured for setting parameters of color pictures, and receiving chromaticity coordinates of all color pictures displayed by the LCD 20, the chromaticity coordinates being generated by the color analyzing device 30.

The LCD 20 mainly includes a second VGA port 21 and a display panel 22. The second VGA port 21 is connected with the first VGA port 11 via a connecting line 40. The connecting line 40 can be a video line. The display panel 22 is configured for displaying color pictures according to the set parameters.

The color analyzing device 30 includes an output port 31 and a camera lens 32. The output port 31 connects with the serial port 12 via a connecting line 50. The camera lens 32 is configured for gathering color information of the color pictures displayed on the display panel 22. The color pictures include a red picture, a green picture, a blue picture, a white picture, gray scale pictures, and so on. The color analyzing device 30 processes the color information, and generates corresponding chromaticity coordinates (x, y, Y). In the preferred embodiment, the color analyzing device 30 can be a 7120 type. That is, the color analyzing device 30 can be a “chroma 7120”. The connecting line 50 transmits chromaticity coordinates (x, y, Y) that are generated by the chroma 7120 to the serial port 12 via the output port 31. The system 1 converts the chromaticity coordinates (x, y, Y) into numerical coordinates (X, Y, Z) of the PCS in order to create an ICC profile. The ICC profile includes a file header, a tag list, and tag element data.

In a chromaticity coordinate expression (x, y, Y), the characters x and y represent values of the chromaticity coordinates respectively, and the character Y represents a brightness value of a color picture. The numerical coordinate expression (X, Y, Z) is a color coordinate system that is set by the International Color Consortium.

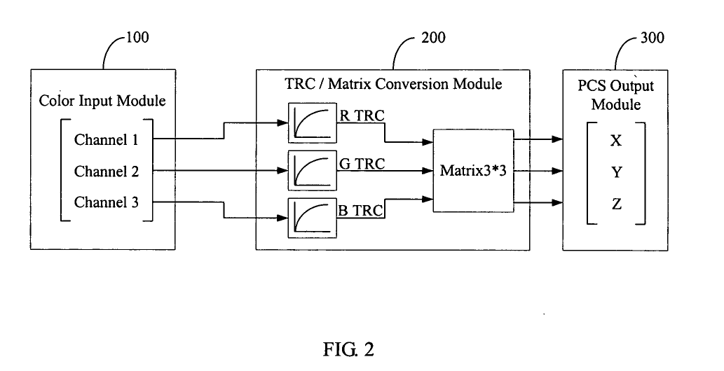

FIG. 2 is a schematic diagram of function modules of color space transformation, the function modules being provided in the system 1 of FIG. 1. The function modules of color space transformation typically include a color input module 100, a tune reproduce curve (TRC)/matrix conversion module 200, and a profile connection space (PCS) output module 300. The color input module 100 is configured for inputting three primary colors (R, G, B) to the TRC/matrix conversion module 200. The TRC/matrix conversion module 200 is configured for analyzing the linear relation of coordinates of the three primary colors in a color picture, and converting the linear relation of coordinates of the three primary colors into chromaticity coordinates (x, y, Y). The chromaticity coordinates (x, y, Y) of the three primary colors are then converted into numerical coordinates (X, Y, Z) of the PCS respectively through calculation according to the following formulas: X=x/y*Y, Z=(1−x−y)/y*Y These formulas are well known in the field of color transformation. The PCS output module 300 is configured for outputting the numerical coordinates (X, Y, Z) in digital form for generating an ICC profile.

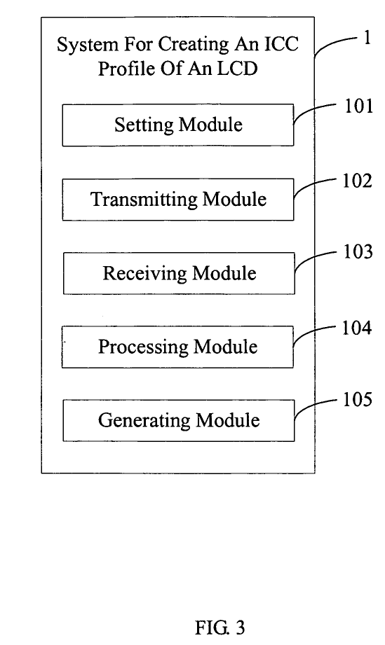

FIG. 3 is a schematic diagram of key software function modules of the system 1. The system 1 includes a setting module 101, a transmitting module 102, a receiving module 103, a processing module 104, and a generating module 105.

The setting module 101 is configured for setting parameters of color pictures. The color pictures include a red picture, a green picture, a blue picture, a white picture, gray scale pictures, and so on.

The transmitting module 102 is configured for transmitting the set parameters to the LCD 20 via the first VGA port 11. The display panel 22 displays color pictures according to the set parameters. The camera lens 32 gathers color information of the color pictures displayed on the display panel 22. The color analyzing device 30 processes the color information, and generates chromaticity coordinates (x, y, Y).

The receiving module 103 is configured for receiving the chromaticity coordinates (x, y, Y). The processing module 104 is configured for converting the chromaticity coordinates (x, y, Y) into the numerical coordinates (X, Y, Z) of the PCS by calculation according to the formulas: X=x/y*Y, Z=(1−x−y)/y*Y, as described above.

The generating module 105 is configured for generating a file header, and inputting the numerical coordinates (X, Y, Z) as tag element data into corresponding positions of the tag list, such that an ICC profile is generated.

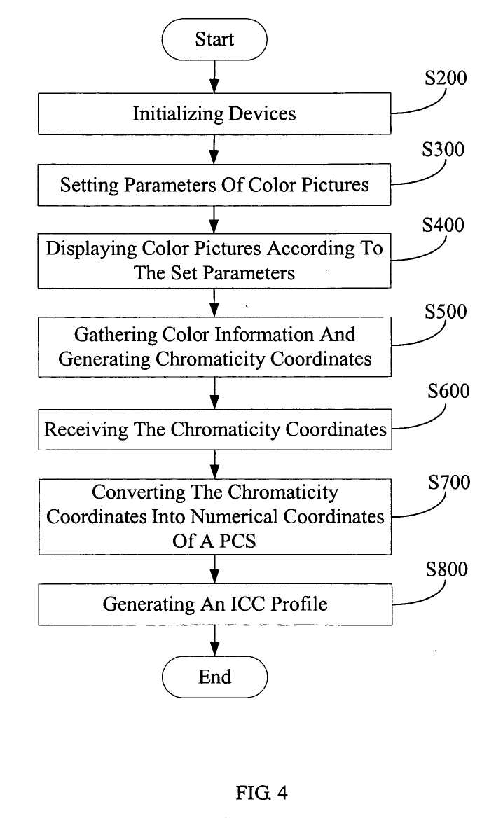

FIG. 4 is a flowchart of a preferred method for creating an ICC profile of an LCD in accordance with another preferred embodiment of the present invention. In step S200, a user initializes the host computer 10 and the color analyzing device 30.

In step S300, the setting module 101 sets the parameters of color pictures, and the transmitting module 102 transmits the set parameters to the LCD 20 via the first VGA port 11. In step S400, the display panel 22 displays color pictures according to the set parameters.

In step S500, the camera lens 32 gathers color information of the color pictures. The color analyzing device 30 processes the color information, and generates corresponding chromaticity coordinates (x, y, Y) through color space transformation as described above in relation to FIG. 2.

In step S600, the receiving module 103 receives the chromaticity coordinates (x, y, Y) via the serial port 12.

In step S700, the processing module 104 converts the chromaticity coordinates (x, y, Y) into numerical coordinates (X, Y, Z) of the PCS by means of calculation as is known in the color transformation art.

In step S800, the generating module 105 generates the file header and tag list, and inputs the numerical coordinates (X, Y, Z) of the PCS into corresponding positions of the tag list in order to generate the ICC profile.

It should be emphasized that the above-described embodiments including any “preferred” embodiments are merely examples of implementations of the present invention, which are set forth for a clear understanding of the principles of the invention. Many variations and modifications may be made to the above-described embodiments without departing substantially from the spirit and principles of the invention. All such variations and modifications are intended to be included herein within the scope of this disclosure and protected by the following claims.

What is claimed is:

1. A system for creating an international color consortium (ICC) profile of a liquid crystal display (LCD), the system configured in a host computer, the system comprising:
a setting module configured for setting parameters of color pictures;
a transmitting module configured for transmitting the set parameters of color pictures to the LCD for displaying of corresponding color pictures;
a receiving module configured for receiving chromaticity coordinates that are generated according to color information of the color pictures displayed by the LCD;
a processing module configured for converting the chromaticity coordinates into numerical coordinates of a profile connection space (PCS); and
a generating module configured for generating an ICC profile according to the numerical coordinates of the PCS.

2. The system according to claim 1, wherein the color pictures comprise any one or more items selected from the group consisting of a red picture, a green picture, a blue picture, a white picture, and gray scale pictures.

3. The system according to claim 1, wherein the numerical coordinates of the PCS conform to a color coordinate system that is set by the International Color Consortium™.

4. A method for creating an international color consortium (ICC) profile of a liquid crystal display (LCD), the method comprising:
setting parameters of color pictures;
displaying color pictures according to the set parameters;
gathering color information of the color pictures, and generating chromaticity coordinates according to the color information; and
converting the chromaticity coordinates into numerical coordinates of a profile connection space (PCS).

5. The method according to claim 4, further comprising a step of generating an ICC profile according to the numerical coordinates of the PCS.

6. The method according to claim 5, wherein the color pictures comprise any one or more items selected from the group consisting of a red picture, a green picture, a blue picture, a white picture, and gray scale pictures.

7. The method according to claim 5, wherein the numerical coordinates of the PCS conform to a color coordinate system that is set by the International Color Consortium™.
